(19) United States
(12) Patent Application Publication
(10) Pub. No.: US 2026/0227098 A1
(43) Pub. Date: Aug. 6, 2026

(54) WATERWAY STRUCTURE AND WATER HEATER

(71) Applicant: JUNSKY APPLIANCES LIMITED, Zhongshan (CN)

(72) Inventors: Weiliang PAN, Zhongshan (CN); Jianbiao TAO, Yiyang (CN); Youqiang XIE, Zhongshan (CN); Yun LUO, Zhongshan (CN)

(21) Appl. No.: 19/634,160

(22) Filed: Mar. 31, 2026

(30) Foreign Application Priority Data
Feb. 28, 2026 (CN) 202620244270.5

(51) Int. Cl. F24H 15/31; F16K 31/06; F24H 1/12; F24H 15/18

(52) U.S. Cl. CPC F24H 15/31; F16K 31/0675; F24H 1/124; F24H 15/18

(57) ABSTRACT

A waterway structure, including: an inlet pipe, a flow regulating valve having a first water inlet and a first water outlet, an on-off valve having a second water inlet and a second water outlet arranged opposite to each other, a transition valve core rotatably disposed in a valve cavity of the on-off valve about a predetermined axis. The second water inlet and the second water outlet are fluidly aligned to establish a continuous flow path along a preset water flow direction; the second water inlet are connected to the first water outlet, and the second water outlet is configured to be connected to a heating assembly. The predetermined axis is perpendicular to the preset water flow direction. The transition valve core is provided with a water flow passage extending therethrough along a flow direction, the flow direction is perpendicular to the predetermined axis.

### CROSS REFERENCE TO RELATED APPLICATIONS

This application claims foreign priority of Chinese Patent Application No. 202620244270.5, filed on February 28, 2026 in the China National Intellectual Property Administration, the entire disclosure of which is hereby incorporated by reference.

### TECHNICAL FIELD

The present disclosure relates to the technical field of household appliances, in particular to a waterway structure and a water heater.

### BACKGROUND

A gas water heater is a household appliance commonly used in daily life. It generally includes a housing, a burner, a heat exchanger, and a waterway control valve assembly and other components arranged in the housing. The waterway control valve assembly typically includes an on-off valve for controlling water flow and a component for detecting and regulating the water flow. In some conventional configurations, when the on-off valve is arranged upstream of the flow regulating valve and is in a closed state, the flow regulating valve and adjacent flow passages may become partially or completely devoid of water due to backflow or pressure release. When the on-off valve is instantaneously opened, the upstream water pressure may cause the water flow to rapidly enter the flow passage as a high-speed jet. If the flow regulating mechanism is at a relatively small opening degree (i.e., the flow passage is narrow), the high-speed jet will directly impact a local region of the impeller inside the flow regulating valve, resulting in uneven force on the impeller and unstable starting rotation.

The above problems cause instantaneous fluctuations in the flow detection signal, making it difficult to accurately determine the actual inlet water flow and affecting user comfort. Under long-term operation, such non-uniform impact may accelerate impeller wear and reduce the service life of the flow regulating valve.

An objective of the present disclosure is to provide a waterway structure and a water heater, which improves the structural arrangement of the waterway control valve assembly, enhances the startup stability of the flow regulating valve, and increases flow detection accuracy.

The present disclosure provides a waterway structure, including: an inlet pipe; and a flow regulating valve having a first water inlet and a first water outlet, the first water inlet being connected to the inlet pipe; and an on-off valve having a second water inlet and a second water outlet arranged opposite to each other, wherein the second water inlet and the second water outlet being fluidly aligned to establish a continuous flow path along a preset water flow direction; the second water inlet being connected to the first water outlet, and the second water outlet is configured to be connected to a heating assembly; and a transition valve core rotatably disposed in a valve cavity of the on-off valve about a predetermined axis, the predetermined axis being perpendicular to the preset water flow direction; the transition valve core is provided with a water flow passage extending therethrough along a flow direction, the flow direction being perpendicular to the predetermined axis; wherein, when the on-off valve is in a closed state, the valve cavity is isolated from an upstream flow passage of the on-off valve, and the transition valve core is positioned at a first angular position relative to the on-off valve such that the flow direction is perpendicular to the preset water flow direction; and when the on-off valve is in an open state, the valve cavity is communicated with the upstream flow passage of the on-off valve, and the transition valve core rotates relative to the on-off valve in a self-adjusting direction under an impact force of the water flow entering the valve cavity to a second angular position, thereby aligning the water flow passage with both the second water inlet and the second water outlet.

Furthermore, the flow regulating valve comprises a valve body, an impeller, and a flow sensor; wherein the valve body is provided with the first water inlet and the first water outlet arranged along a preset water flow direction; and the impeller and the flow sensor are disposed within the valve body; the impeller is rotatably connected to an inner wall of the valve body along a direction perpendicular to both the first water inlet and the first water outlet; the impeller is configured to rotate under the driving force of water flow through the first water inlet and the first water outlet; and the flow sensor is configured to generate a water flow detection signal based on rotation of the impeller.

Furthermore, the inlet pipe, the flow regulating valve, and the on-off valve are arranged coaxially along the preset water flow direction; and the on-off valve is a solenoid valve or an electrically actuated valve.

Furthermore, the transition valve core is configured as a cylinder extending along the predetermined axis; wherein an outer cylindrical surface of the transition valve core is provided with a spiral groove extending circumferentially around the transition valve core; and the spiral groove is configured to allow water flow to pass therethrough.

Furthermore, an outer cylindrical surface of the transition valve core is provided with a plurality of baffles arranged at intervals along the circumference of the transition valve core; wherein the plurality of baffles being inclined relative to a radial direction of the transition valve core, and configured to drive the transition valve core to rotate about the predetermined axis under the impact force of the water flow.

Furthermore, each of the plurality of baffles has a bucket-shaped structure.

Furthermore, the bucket-shaped structure has a concave surface, and concave surfaces of all the bucket-shaped structures of the plurality of baffles face a same direction.

Furthermore, waterway structure also includes a limiting structure, wherein the limiting structure comprises a limiting boss and a limiting block; wherein the limiting boss is disposed on an inner wall of the valve cavity of the on-off valve and is located at one side of the transition valve core; the limiting block is disposed at an end of the transition valve core adjacent to the limiting boss; and when the transition valve core rotates to the second angular position, the limiting block abuts against the limiting boss.

Furthermore, one of the limiting boss and the limiting block is an electromagnetic member and the other is a permanent magnet member; and wherein when the transition valve core rotates to the second angular position, the electromagnetic member is energized and magnetically attracts the permanent magnet member, thereby positioning the transition valve core at the second angular position.

Furthermore, the electromagnetic member is energized when the on-off valve is in the open state and de-energized when the on-off valve is in the closed state.

Furthermore, waterway structure also includes a reset assembly connected to an outer peripheral surface of the transition valve core and to an inner wall of the on-off valve; wherein the reset assembly is configured to drive the transition valve core to rotate from the second angular position back to the first angular position.

Furthermore, the reset assembly is a torsion spring, wherein the torsion spring comprises a main body portion, a first arm, and a second arm; wherein the main body portion is sleeved on one end of the transition valve core; the first arm is connected to the outer peripheral surface of the transition valve core; and the second arm is fixedly connected to the inner wall of the on-off valve.

Furthermore, a cross-sectional area of the water flow passage increases along the preset water flow direction.

Furthermore, a cross-section of the water flow passage is circular, elliptical, or rectangular.

Furthermore, waterway structure also includes a water flow adjustment knob for user operation; wherein the water flow adjustment knob is mechanically or electrically linked with the flow regulating valve and is configured to adjust the opening degree of the flow regulating valve.

Furthermore, the water flow adjustment knob has a push-and-rotate operation structure; wherein a push operation generates an on/off control signal for the on-off valve, and a rotate operation generates an opening-degree adjustment signal for the flow regulating valve.

Furthermore, a filter component is disposed between the first water inlet and the inlet pipe; the filter component is configured to filter impurities from water entering the waterway structure.

To realize the above objective, the present disclosure provides a water heater, including: the waterway structure mentioned above; a housing defining an installation space; wherein the installation space is configured to accommodate the waterway structure, and one end of the inlet pipe remote from the flow regulating valve is extended outside of the housing and connected with an external water supply channel; a heat exchanger disposed within the installation space; wherein the heat exchanger having a third water inlet and a third water outlet, the third water inlet is connected to the second water outlet; wherein the heat exchanger is configured to heat water flow through the waterway structure; an outlet pipe, one end of the outlet pipe is connected to the third water outlet and the other end is extended outside of the housing to output hot water heated by the heat exchanger.

The water heater further includes a burner and a flue gas exhaust assembly; wherein the burner is disposed below the heat exchanger and is configured to combust combustible gas to generate high-temperature flue gas for heating the heat exchanger; the flue gas exhaust assembly comprises a flue exhaust passage and a blower; and the blower is disposed above or beside the burner and is configured to discharge flue gas generated by combustion of the combustible gas through the flue exhaust passage.

The water heater further includes an operation panel disposed on a front side of the housing; wherein the operation panel is provided with a temperature adjustment component and a water flow adjustment knob; wherein the temperature adjustment component is connected to a heating power control unit of the burner and is configured to adjust the heating power of the burner according to a temperature set by a user.

In the technical solution of the present disclosure, the on-off valve is disposed downstream of the flow regulating valve. When the on-off valve is in a closed state, the flow passage between the flow regulating valve and the upstream valve cavity of the on-off valve remains filled with water, thereby reducing or preventing air accumulation in the flow passage. As a result, when the on-off valve is opened, water flows through the system under relatively stable pressure conditions, which helps reduce the occurrence of high-velocity jet flow impacting internal components of the flow regulating valve.

In addition, a transition valve core is arranged within the on-off valve. Under the influence of incoming water flow, the transition valve core is configured to rotate gradually in a self-adjusting manner until water passage openings within the transition valve core are aligned with the corresponding inlet and outlet of the on-off valve. During this process, the transition valve core provides a buffering effect on the water flow, thereby moderating the rate of flow increase and reducing turbulence.

Consequently, fluctuations in the flow detection signal may be reduced, detection accuracy may be improved, and wear of internal components of the flow regulating valve may be alleviated, thereby extending the service life of the flow regulating valve.

### BRIEF DESCRIPTION OF THE DRAWINGS

To more clearly illustrate the technical solutions in the embodiments of the present disclosure or in the prior art, the drawings required for describing the embodiments or the prior art are briefly introduced below. Obviously, the drawings in the following description are merely some embodiments of the present disclosure. For those of ordinary skill in the art, other drawings may be obtained according to the structures shown in these drawings without creative effort.

FIG. 1 is a schematic diagram of a waterway structure and a water heater having the waterway structure according to one embodiment of the present disclosure.

FIG. 2 is an exploded view of a waterway structure and a water heater shown in FIG. 1.

FIG. 3 is a schematic diagram of a transition valve core inside an on-off valve of the waterway structure at a first angular position.

FIG. 4 is a schematic diagram of the transition valve core at a second angular position.

FIG. 5 is a partial cross-sectional view of the transition valve core at a second angular position.

FIG. 6 is a schematic diagram of a reset assembly within the on-off valve.

FIG. 7 is a schematic diagram of the transition valve core at a second angular position.

FIG. 8 is a cross-sectional view of the waterway structure.

FIG. 9 is a schematic diagram of a flow regulating valve and an inlet pipe.

FIG. 10 is a schematic diagram of the waterway structure and the water heater.

FIG. 11 is a schematic diagram illustrating a connection principle of the waterway structure.

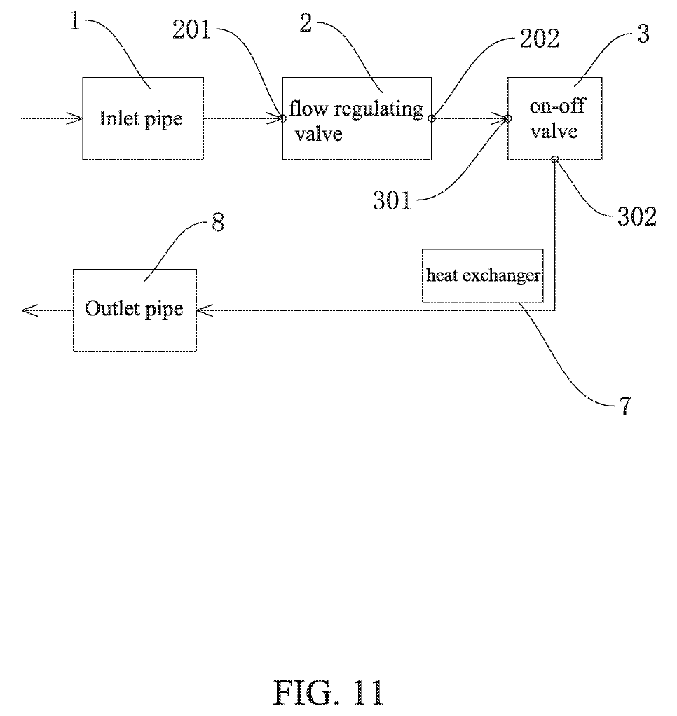

### Description of the reference numerals:

100 water supply system, 1 inlet pipe, 2 flow regulating valve, 201 first water inlet, 202 first water outlet, 203 valve body, 204 impeller, 205 flow sensor, 3 on-off valve, 301 second water inlet, 302 second water outlet, 303 valve cavity, 4 fixed bracket, 5 water flow adjustment knob, 6 housing, 601 installation space, 602 lower shell, 603 upper cover, 7 heat exchanger, 701 third water inlet, 702 third water outlet, 8 outlet pipe, 9 operation panel, 10 burner, 101 flue gas exhaust assembly, 1011 flue exhaust channel, 1012 blower, 11 temperature adjustment component, 12 water conduit, 13 transition valve core, 1301 water flow passage, 1302 spiral groove, 14 baffle, 1401 concave surface, 15 limiting structure, 1501 limiting boss, 1502 limiting block, 16 reset assembly, 1601 main body portion, 1602 first arm, 1603 second arm, 17 filter component.

The technical solutions in the embodiments of the present disclosure will be clearly and completely described below in conjunction with the accompanying drawings in the embodiments of the present disclosure.

### DETAILED DESCRIPTION OF THE EMBODIMENTS

The technical solutions in the embodiments of the present disclosure will be clearly and completely described below with reference to the accompanying drawings in the embodiments of the present disclosure. It is evident that the described embodiments are merely a part of the embodiments of the present disclosure, rather than all of the embodiments. All other embodiments obtained by a person of ordinary skill in the art based on the embodiments in the present disclosure without creative efforts shall fall within the protection scope of the present disclosure.

It should be noted that, if directional indications (such as up, down, left, right, front, rear, and the like) are involved in the embodiments of the present disclosure, such directional indications are merely used to explain the relative positional relationship, movement situation, and the like among the various components in a specific posture; if the specific posture changes, the directional indications will also change correspondingly.

In addition, if descriptions involving “first,” “second,” and the like appear in the embodiments of the present disclosure, such descriptions of “first,” “second,” and the like are used for descriptive purposes only and should not be construed as indicating or implying relative importance or implicitly specifying the number of the indicated technical features. Therefore, features defined as “first” or “second” may explicitly or implicitly include at least one of the features. In addition, if “and/or” or “and/or” appears throughout the text, its meaning includes three parallel solutions; taking “A and/or B” as an example, it includes the solution A, or the solution B, or the solution in which both A and B are satisfied. In addition, the technical solutions of the various embodiments may be combined with each other, but such combination must be based on what can be realized by a person of ordinary skill in the art; when the combination of the technical solutions is contradictory or cannot be realized, it should be considered that such a combination of the technical solutions does not exist and does not fall within the protection scope claimed by the present disclosure.

A gas water heater is a household appliance commonly used in daily life. It generally includes a housing, a burner, a heat exchanger, and a waterway control valve assembly and other components arranged in the housing. The waterway control valve assembly typically includes an on-off valve for controlling water flow and a component for detecting and regulating the water flow. In some conventional configurations, when the on-off valve is arranged upstream of the flow regulating valve and is in a closed state, the flow regulating valve and adjacent flow passages may become partially or completely devoid of water due to backflow or pressure release. When the on-off valve is instantaneously opened, the upstream water pressure may cause the water flow to rapidly enter the flow passage as a high-speed jet. If the flow regulating mechanism is at a relatively small opening degree (i.e., the flow passage is narrow), the high-speed jet will directly impact a local region of the impeller inside the flow regulating valve, resulting in uneven force on the impeller and unstable starting rotation.

These additions may cause instantaneous fluctuations in the flow detection signal, making it difficult to accurately determine the actual inlet water flow and affecting user comfort. Under long-term operation, such non-uniform impact may accelerate impeller wear and reduce the service life of the flow regulating valve.

In order to solve the above problems, the present disclosure provides a waterway structure.

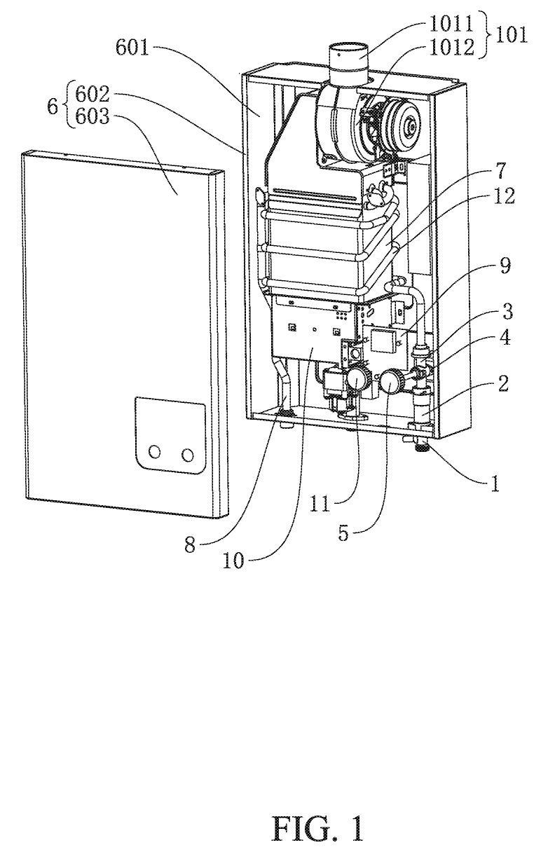

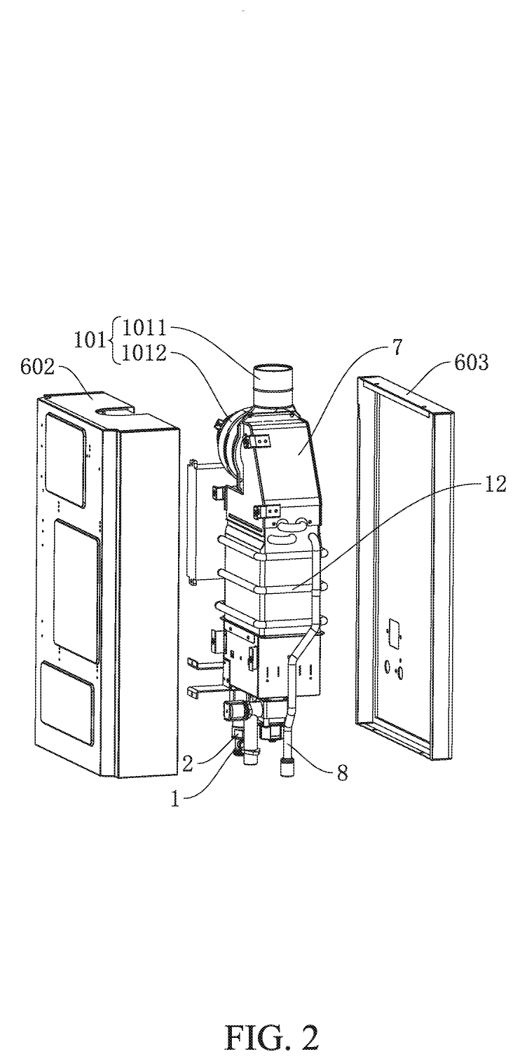

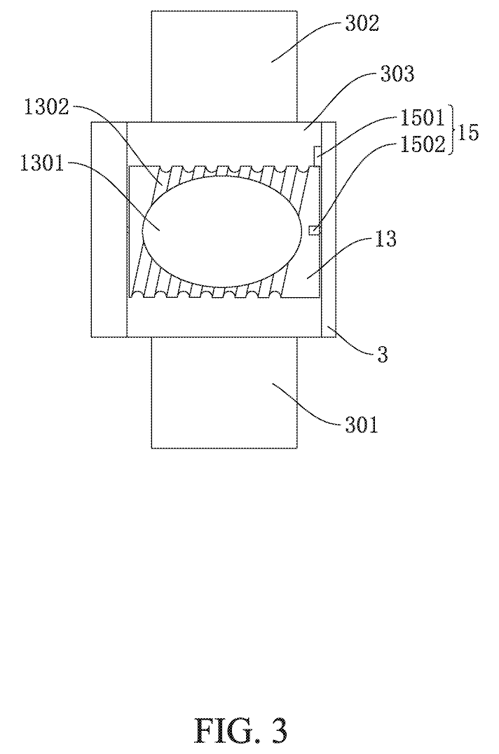

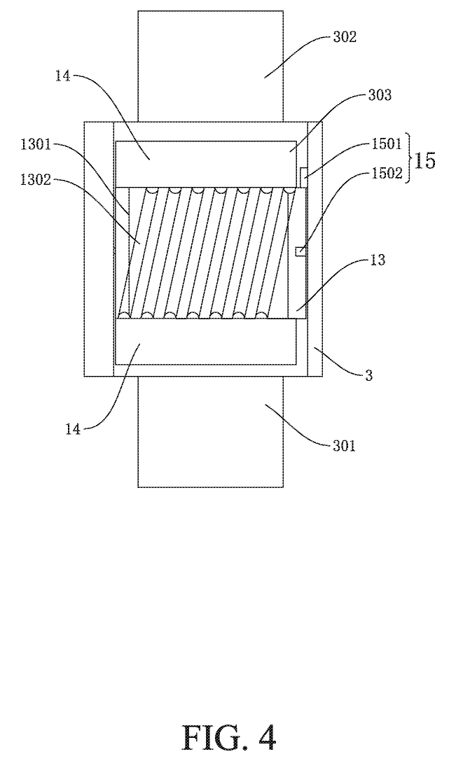

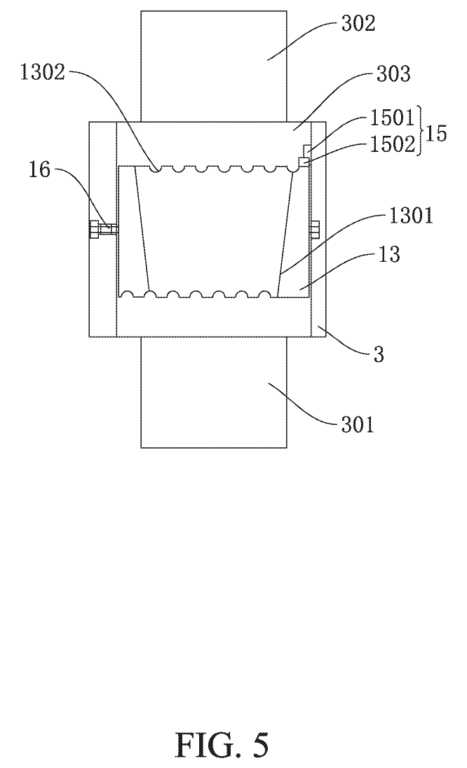

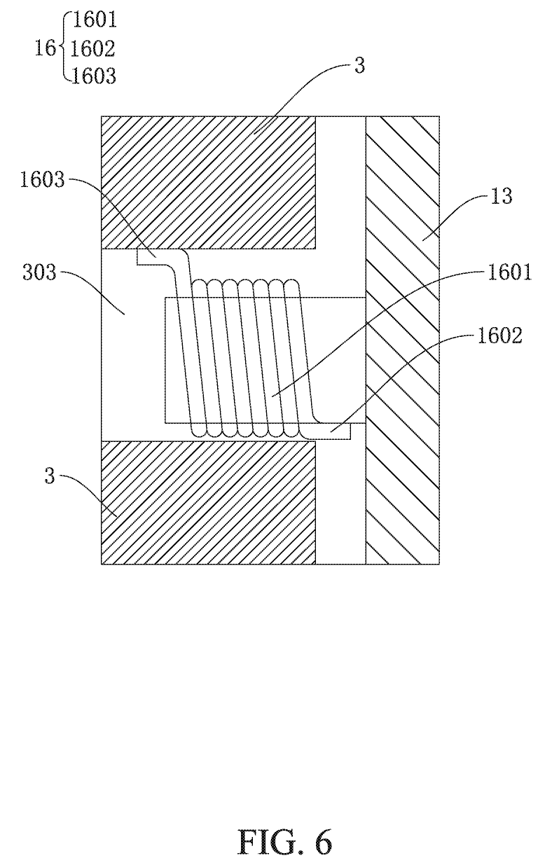

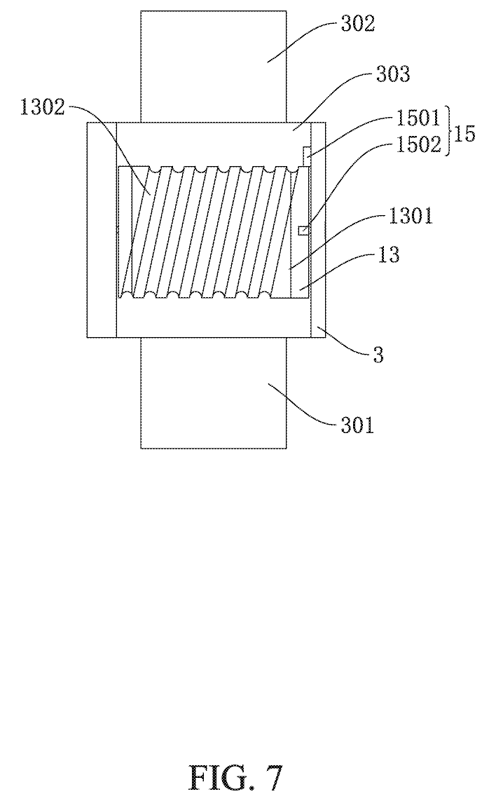

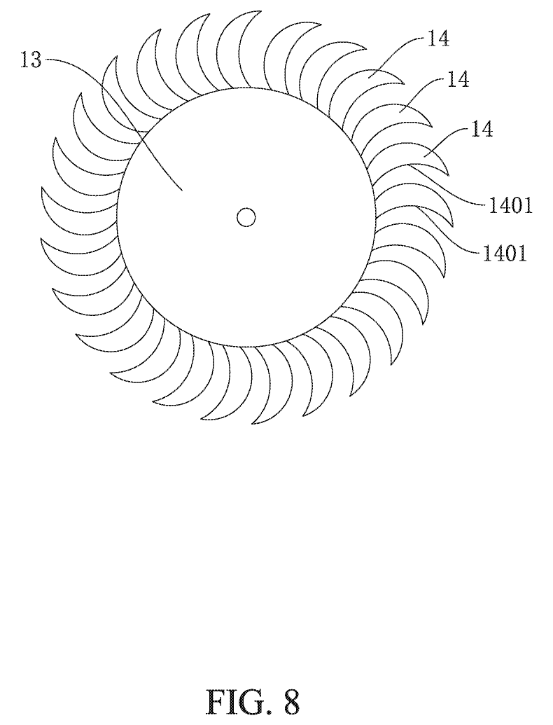

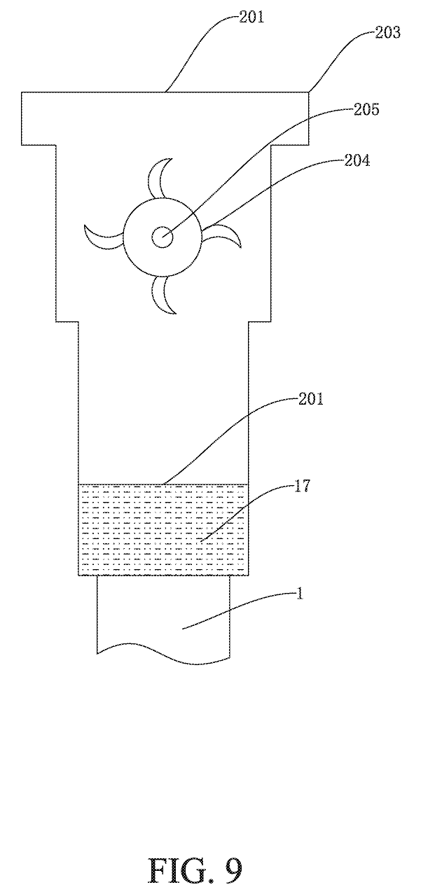

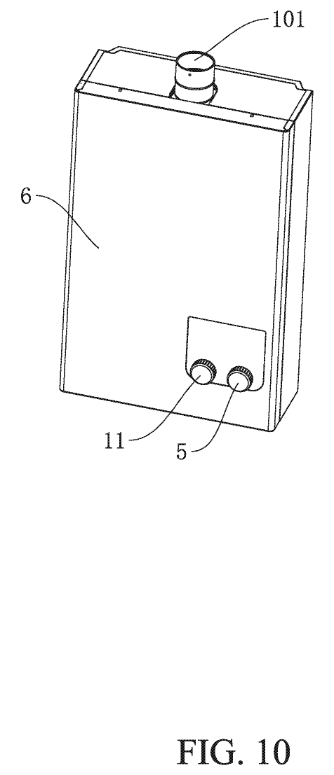

Referring to FIGS. 1 to 10, in this embodiment, the waterway structure includes an inlet pipe 1, a flow regulating valve 2, an on-off valve 3, and a transition valve core 13. The flow regulating valve 2 has a first water inlet 201 and a first water outlet 202, and the first water inlet 201 is connected with the inlet pipe 1. The on-off valve 3 has a second water inlet 301 and a second water outlet 302 that are oppositely arranged, and the second water inlet 301 and the second water outlet 302 are arranged along a preset water flow direction. The second water inlet 301 is connected with the first water outlet 202, and the second water outlet 302 is used for connecting with a heating assembly. The transition valve core 13 is rotatably disposed within a valve cavity 303 of the on-off valve 3 about a preset axis, and the preset axis is perpendicular to the preset water flow direction. The transition valve core 13 is provided with a water flow passage 1301 extending through the transition valve core 13 along a flow direction perpendicular to the preset axis.

When the on-off valve 3 is in a closed state, the valve cavity 303 is isolated from the upstream flow passage of the on-off valve 3. The transition valve core 13 is at a first angular position relative to the on-off valve 3, and the flow direction is perpendicular to the preset water flow direction. When the on-off valve 3 is in an open state, the valve cavity 303 communicates with the upstream flow passage of the on-off valve 3. The transition valve core 13 rotates from a first angular position to a second angular position under the impact force of water entering the valve cavity 303, thereby aligning the water flow passage 1301 with the second water inlet 301 and the second water outlet 302.

When the transition valve core 13 is at the first angular position, the water flow passage is oriented perpendicular to the preset water flow direction. When the transition valve core 13 is at the second angular position, the water flow passage 1301 is aligned with the second water inlet 301 and the second water outlet 302.

The inlet pipe 1 is used for connecting with an external water supply system 100. The flow regulating valve 2 has a first water inlet 201 and a first water outlet 202. The first water inlet 201 is connected with the inlet pipe 1, and a sensor for detecting water flow rate is arranged inside the flow regulating valve 2. The on-off valve 3 has a second water inlet 301 and a second water outlet 302 that are oppositely arranged along the preset water flow direction. The second water inlet 301 is connected with the first water outlet 202, so that the on-off valve 3 is located downstream of the flow regulating valve 2. The second water outlet 302 is used for connecting with the heating assembly. The transition valve core 13 is rotatably arranged in the valve cavity 303 of the on-off valve 3, the rotation axis of the transition valve core 13 is the preset axis, and the preset axis is perpendicular to the preset water flow direction. A water flow passage 1301 is provided inside the transition valve core 13, the water flow passage 1301 penetrates through the transition valve core 13 along the flow direction, and the flow direction is perpendicular to the preset axis.

When the on-off valve 3 is in the closed state, the transition valve core 13 is positioned at a first angular position. At this position, the flow direction of the water flow passage 1301 is perpendicular to the preset water flow direction, and its openings at both ends of the water flow passage 1301 are staggered with respect to the second water inlet 301 and the second water outlet 302. Since the on-off valve 3 is located downstream of the flow regulating valve 2, in the closed state, the flow path from the first water outlet 202 of the flow regulating valve 2 to the second water inlet 301 of the on-off valve 3, together with the upstream valve cavity 303 of the on-off valve 3, is filled with water, thereby eliminating air accumulation within that segment of the flow path. When the on-off valve 3 is in the open state, the water flow enters the valve cavity 303 from the second water inlet 301 and impacts the surface of the transition valve core 13, generating a torque about the predetermined axis and thereby driving the transition valve core 13 to gradually rotate along a self-adjusting direction. During the rotation process, the flow direction of the water flow passage 1301 gradually transitions from being perpendicular to the preset water flow direction toward parallelism therewith. The relative area between the openings of the water flow passage 1301 and each of the second water inlet 301 and the second water outlet 302 gradually increases from small to large, such that the water flow passage area expands in a graduated manner and thereby exerts a buffering effect on the water flow. When the transition valve core 13 rotates to the second angular position, the flow direction of the water flow passage 1301 tends to coincide with the preset water flow direction, and the openings at both ends of the water flow passage 1301 are respectively positioned opposite to the second water inlet 301 and the second water outlet 302, thereby forming a through waterway.

Owing to the fact that the upstream flow passage is already in a fully water-filled state prior to opening of the on-off valve 3, and that the transition valve core 13 progressively conducts the water flow during its rotation process, the water flow enters the on-off valve 3 at an instant of opening with stable pressure and a gentle rate of flow increase. Therefore, the high-speed jet flow is avoided, preventing direct impact on an internal impeller or a flow-detection component that would otherwise be formed by instantaneous opening of an upstream on-off valve in conventional solutions, thereby ensuring uniform force distribution inside the flow regulating valve 2, smooth startup of the impeller, reduction of fluctuations in the flow-detection signal, improvement of detection accuracy, alleviation of impeller wear, and extension of service life.

In one embodiment, the flow regulating valve 2 includes a valve body 203, an impeller 204, and a flow sensor 205, wherein the valve body 203 is arranged along the preset flow direction with a first water inlet 201 and a first water outlet 202 disposed therein, the impeller and the flow sensor are provided inside the valve body 203, and the impeller is rotatably connected to the inner wall of the valve body 203 along a direction perpendicular to the first water inlet 201 and the first water outlet 202, the impeller being driven to rotate by the water flow passing through the first water inlet 201 and the first water outlet 202, while the flow sensor is configured to generate a water flow detection signal according to the rotation of the impeller.

The valve body 203 is arranged along the preset flow direction with a first water inlet 201 and a first water outlet 202 disposed therein, the impeller 204 and the flow sensor 205 are provided inside the valve body 203. The impeller 204 is rotatably connected to the inner wall of the valve body 203 along a direction perpendicular to the first water inlet 201 and the first water outlet 202. The impeller 204 is driven to rotate by the water flow passing through the first water inlet 201 and the first water outlet 202, while the flow sensor 205 is configured to generate a water flow detection signal according to the rotation of the impeller 204. Specifically, a flow passage allowing water to pass therethrough is formed inside the valve body 203, the first water inlet 201 and the first water outlet 202 are respectively located at the upstream end and the downstream end of the flow passage, and the direction of the line connecting the two constitutes the preset flow direction. The impeller 204 is mounted inside the valve body 203 with its rotational axis oriented perpendicular to the preset flow direction. For example, when the preset flow direction is horizontal, the rotational axis of the impeller 204 is arranged in the vertical direction. The impeller 204 is provided with a plurality of blades. When water flows in from the first water inlet 201, passes through the interior of the valve body 203, and proceeds toward the first water outlet 202, the water flow impinges upon the blade surfaces, applying a circumferential force to the impeller 204, thereby driving the impeller 204 to rotate about its rotational axis. The rotational speed of the impeller 204 is positively correlated with the water flow velocity. The flow sensor 205 is disposed adjacent to the impeller 204 and may take the form of a Hall sensor, a photoelectric sensor, an electromagnetic induction element, or the like. By detecting the rotational speed of the impeller 204 or the passing frequency of magnetic poles on the impeller 204, the element generates an electrical signal corresponding to the flow rate for use by an external control system in performing flow monitoring and regulation. By configuring the impeller 204 such that its rotational axis is perpendicular to the water flow direction, the impeller 204 is able to obtain a larger driving torque under the impact force of the water flow, with sensitive startup and stable rotation, which is advantageous for improving the response speed and signal stability of flow detection.

In one embodiment, the inlet pipe 1, the flow regulating valve 2, and the on-off valve 3 are arranged sequentially and coaxially along the preset water flow direction. The on-off valve 3 is a solenoid valve or an electrically actuated valve.

The preset water flow direction is the straight line direction in which water flows from upstream to downstream. The water outlet end of the inlet pipe 1, the first water inlet 201 and the first water outlet 202 of the flow regulating valve 2, and the second water inlet 301 and the second water outlet 302 of the on-off valve 3 are all arranged along the straight-line direction, and the central axes of the respective components coincide or lie on the same straight line. This coaxial arrangement ensures that, during the process in which water flows from the inlet pipe 1 into the flow regulating valve 2 and then from the flow regulating valve 2 into the on-off valve 3, the flow direction undergoes neither deflection nor turning, and the flow passage remains in a straight and continuous through state, thereby reducing localized turbulence and pressure losses caused by direction changes, enabling the water flow to enter the on-off valve 3 in a more stable flow regime, and simultaneously simplifying the connection structures among the components while rendering the overall waterway layout more compact.

On the other hand, the on-off valve 3 may be implemented as a solenoid valve or an electrically actuated valve. A solenoid valve refers to a valve whose valve core action is controlled by energization and de-energization of an electromagnetic coil. An electromagnetic coil, a movable iron core, and a return spring are provided inside the solenoid valve. When the electromagnetic coil is energized, electromagnetic force is generated to attract the movable iron core to move, thereby driving the valve core to switch the valve-port state. When the electromagnetic coil is de-energized, the movable iron core resets under the action of the return spring. An electrically actuated valve refers to a valve whose valve core action is controlled by motor drive. A micro-motor and a transmission mechanism are provided inside the electrically actuated valve. When the motor rotates forward or in reverse, the valve core is driven to move or rotate via transmission components such as gears or lead screws, thereby realizing opening and closing of the second water inlet 301 of the on-off valve 3. In this embodiment, whether the valve is a solenoid valve or an electrically actuated valve, its valve core is linked with and cooperates with the transition valve core 13. When an external control system issues an opening command to the solenoid valve or electrically actuated valve, the valve core acts to permit water flow to pass through and drive the transition valve core 13 to rotate. By configuring the on-off valve 3 as a solenoid valve or an electrically actuated valve, the opening and closing actions of the on-off valve 3 can be precisely controlled by electrical signals, facilitating closed-loop control in conjunction with the detection signal of the flow regulating valve 2 while mutually complementing the self-adjusting function of the transition valve core 13 under water flow impingement.

In one embodiment, the transition valve core 13 is configured as a cylinder extending along the preset axis direction, and the outer cylindrical surface of the transition valve core 13 is provided with a spiral groove 1302. The spiral groove 1302 is arranged circumferentially around the transition valve core 13 and is configured to allow water flow to pass therethrough.

The transition valve core 13 has a cylindrical outer contour, an axial length of which is adapted to match an axial dimension of the valve cavity 303 of the on-off valve 3. The transition valve core 13 is rotatably mounted within the valve cavity 303, and its cylindrical axis coincides with a predetermined axis, thereby enabling the transition valve core 13 to freely rotate about its own axis. A spiral groove 1302 is disposed on the outer cylindrical surface of the transition valve core 13. The spiral groove 1302 extends circumferentially around the transition valve core 13. The spiral groove 1302 is defined as a channel formed by radially inwardly recessing from the outer cylindrical surface of the transition valve core 13, the channel extending in the form of a helix on the cylindrical surface, that is, continuously varying simultaneously along both the axial direction and the circumferential direction of the transition valve core 13. The spiral groove 1302 may be a single-start helix or a multi-start helix, and the helix angle and the groove depth thereof may be adaptively adjusted according to the desired water flow driving characteristics. Furthermore, the interior of the transition valve core 13 is further provided with a penetrating water flow passage 1301. The water flow passage 1301 extending along the flow direction, and the flow direction is perpendicular to the predetermined axis. Openings at both ends of the water flow passage 1301 are disposed on the cylindrical surface of the transition valve core 13, so as to be positioned opposite to and in communication with the second water inlet 301 and the second water outlet 302 when the transition valve core 13 is rotated to the second angular position.

Specifically, when the second water inlet 301 of the on-off valve 3 is in the open state, after the water flow enters the valve cavity 303 of the on-off valve 3 from the second water inlet 301. The water flow enters the spiral groove 1302 and flows along the extension direction of the spiral groove 1302. Due to the helical structure of the spiral groove 1302, the flow direction of the water flow undergoes continuous deflection when passing through the spiral groove 1302. Thereby applying a circumferential tangential force to the cylindrical surface of the transition valve core 13, the tangential force forming a driving torque about the preset axis. Under the action of the torque, the transition valve core 13 rotates relative to the on-off valve 3 along the self-adjusting direction until the water flow passage 1301 is opposite to the second water inlet 301 and the second water outlet 302. When the water flow stops or the flow rate decreases, the impact force of the water flow within the spiral groove 1302 weakens, and the transition valve core 13 can return to position under the action of the water flow pressure change or the reset assembly 16. In addition, the spiral groove 1302 has a flow-guiding effect on the water flow, causing the water flow to flow along the preset helical path after entering the on-off valve 3, thereby reducing the generation of turbulence and helping to maintain the stability of the water flow.

In one embodiment, the outer cylindrical surface of the transition valve core 13 is provided with a plurality of baffles 14. The plurality of baffles 14 are arranged at intervals along the circumferential direction of the transition valve core 13. The baffles 14 are disposed inclined relative to the radial direction of the transition valve core 13, the baffles 14 are used to drive the transition valve core 13 to rotate about the preset axis under the impact force of the water flow.

The plurality of baffles 14 are arranged at intervals along the circumferential direction of the transition valve core 13, and gaps for water flow to pass through are formed between adjacent baffles 14. The baffles 14 is disposed inclined relative to the radial direction of the transition valve core 13, that is, an acute angle is formed between the extension direction of the baffles 14 and the radial direction of the transition valve core 13. So that the baffles 14 present an inclined blade-like structure on the outer cylindrical surface of the transition valve core 13. The specific shape of the baffles 14 may adopt a rectangular, trapezoidal or arcuate sheet-like structure, and the inclination angle thereof may be set according to the required driving torque magnitude, generally between 30 degrees and 60 degrees. The baffles 14 are used to drive the transition valve core 13 to rotate about the preset axis under the impact force of the water flow. Specifically, when the second water inlet 301 of the on-off valve 3 is opened, after the water flow enters the valve cavity 303 of the on-off valve 3 from the second water inlet 301, the water flow flows along the preset water flow direction and impacts the surfaces of the baffles 14. Because the baffles 14 are inclined relative to the radial direction, the impact force of the water flow on the baffles 14 can be decomposed into a component force perpendicular to the surfaces of the baffles 14 and a component force along the surfaces of the baffles 14. The component force perpendicular to the surfaces of the baffles 14 generates a torque about the preset axis. Under the action of the torque, the transition valve core 13 rotates relative to the on-off valve 3 along the self-adjusting direction. The plurality of baffles 14 are arranged at intervals along the circumferential direction, so that during the rotation of the transition valve core 13, at least one baffle 14 is always within the effective action region of the impact force of the water flow, thereby ensuring the continuity of the driving torque. As the transition valve core 13 rotates, the water flow passage 1301 gradually becomes opposite to the second water inlet 301 and the second water outlet 302.

In one embodiment, each of the baffles 14 is formed as a bucket-shaped structure.

The bucket-shaped structure means that the baffles 14 are in the form of a concave curved surface, and the side thereof facing the incoming water flow direction forms an inwardly concave accommodating space, the overall shape defines a concave cavity configured to receive fluid flow. Specifically, each baffle 14 has a bottom portion, side walls and an open side. The bottom portion is connected to the outer cylindrical surface of the transition valve core 13. The side walls extend forward from both sides of the bottom portion, and the open side facing upstream of the preset water flow direction, so that the concave surface 1401 of the baffle 14 directly faces the incoming water flow direction. The concave curved surface of each baffle 14 may have a circular arc surface or a parabolic surface, and its concave depth and opening width are set according to the required impact force of the water flow to be withstood.

In one embodiment, the bucket-shaped structure has a concave surface 1401, and the concave surfaces 1401 of all the bucket-shaped structures face the same direction.

When the plurality of baffles 14 are arranged at intervals along the circumferential direction of the transition valve core 13, the concave surface 1401 of each baffle 14 faces the same direction. That is, all face a same side of the transition valve core 13. Since the concave surfaces 1401 face the same direction, when the water flow enters the valve cavity 303 of the on-off valve 3 from the second water inlet 301, the water flow flows along the preset water flow direction and simultaneously impacts the concave surfaces 1401 of the respective baffles 14, and the impact force of the water flows received by all the baffles 14 generate torques in the same circumferential direction. These torques are superimposed and jointly drive the transition valve core 13 to rotate about the preset axis along the self-adjusting direction. So that under the same water flow rate condition, the total driving torque obtained by the transition valve core 13 is the sum of the torques of the respective baffles 14, thereby further improving the utilization efficiency of the impact force of the water flow.

In one embodiment, the waterway structure further includes a limiting structure 15. The limiting structure 15 includes a limiting boss 1501 and a limiting block 1502. The limiting boss 1501 is disposed on an inner wall of the valve cavity 303 of the on-off valve 3. The limiting boss 1501 is located at one side along the axial direction of the transition valve core 13. The limiting block 1502 is disposed at an end of the transition valve core 13 close to the limiting boss 1501, and when the transition valve core 13 rotates to the second angular position, the limiting block 1502 abuts against the limiting boss 1501.

The limiting boss 1501 protrudes radially inward from the inner wall of the valve cavity 303 of the on-off valve 3. The protruding height and width of the limiting boss 1501 are configured to engage the limiting block 1502. The limiting boss 1501 may be disposed at one axial end of the valve cavity 303. For example, near the end portion of the transition valve core 13 and located in the region toward which the transition valve core 13 faces its end portion during rotation. Specifically, the shape of the limiting block 1502 may adopt a rectangular block, an arcuate block or a cylindrical protrusion and the like. The protruding direction of the limiting block 1502 faces the side where the limiting boss 1501 is located. The limiting block 1502 and the limiting boss 1501 are disposed opposite each other in the circumferential direction of the transition valve core 13, so that when the transition valve core 13 rotates about the preset axis, the limiting block 1502 rotates synchronously with the transition valve core 13. The transition valve core 13 rotates along the self-adjusting direction under the impact force of the water flow. When the rotation angle reaches the second angular position, the side surface of the limiting block 1502 and the side surface of the limiting boss 1501 come into mutual contact and form an abutment, thereby keeping the openings at both ends of the water flow passage 1301 in a state of being respectively opposite to the second water inlet 301 and the second water outlet 302.

In one embodiment, one of the limiting boss 1501 and the limiting block 1502 is an electromagnetic member, and the other of the limiting boss 1501 and the limiting block 1502 is a permanent magnet member. When the transition valve core 13 rotates to the second angular position, the electromagnetic member is energized and magnetically attracts the permanent magnet member. The electromagnetic member is configured to position the transition valve core 13 at the second angular position.

The electromagnetic member refers to an electromagnet assembly constituted by an electromagnetic coil and an iron core. When the electromagnetic member is energized, a magnetic field is generated internally therein, thereby exhibiting magnetism externally and being capable of attracting the permanent magnet member or a magnetic material. The permanent magnet member inherently possesses a constant magnetic field and is capable of generating a magnetic attraction force externally without requiring energization. In one arrangement configuration, the limiting boss 1501 may be the electromagnetic member and the limiting block 1502 may be the permanent magnet member. In another arrangement configuration, the limiting boss 1501 may be the permanent magnet member and the limiting block 1502 may be the electromagnetic member. Regardless of the combination form adopted, the common characteristic thereof lies in that, when the two are brought into proximity, a connection may be generated through magnetic attractive cooperation.

When the transition valve core 13 rotates to the second angular position, the electromagnetic member is energized and magnetically attracts the permanent magnet member and is configured to position and lock the transition valve core 13 at the second angular position. Specifically, during the rotation process of the transition valve core 13, the limiting block 1502 rotates synchronously with the transition valve core 13. When the transition valve core 13 rotates to the second angular position, the limiting block 1502 contacts the limiting boss 1501. At this time, if the electromagnetic member has not yet been energized, the two merely maintain a mechanical abutting relationship. When an external control system issues an energization command to the electromagnetic member, the electromagnetic member generates a magnetic field and thereby produces a magnetic attraction force with the permanent magnet member. The magnetic attraction force causes the limiting block 1502 and the limiting boss 1501 to tightly attract each other, thereby securely retaining the transition valve core 13 in the second-angle position. Even if the impact force of the water flow decreases or experiences instantaneous fluctuation, under the action of the magnetic attraction force the transition valve core 13 will neither rotate backward nor deviate, thereby maintaining the aligned state of the water flow passage 1301 with the second water inlet 301 and the second water outlet 302. When the on-off valve 3 is in the closed state, the external control system synchronously cuts off the power supply to the electromagnetic member, causing the electromagnetic member to lose its magnetism and causing the magnetic attraction force between the limiting block 1502 and the limiting boss 1501 to disappear, at which time the impact force of the water flow is reduced and the transition valve core 13 can, under the action of the reset assembly 16, disengage from the second-angle position and reset to the first angular position.

In one embodiment, the electromagnetic member is energized when the on-off valve 3 is in the open state. The electromagnetic member is de-energized when the on-off valve 3 is in the closed state.

The external control system issues an opening command to the on-off valve 3, while simultaneously outputting an energization command to the electromagnetic member. When an opening command is issued, the electromagnetic member is energized. When a closing command is issued, the electromagnetic member is de-energized. By configuring the opening/closing of the on-off valve 3 to be synchronously controlled with the energization/de-energization of the electromagnetic member, the electromagnetic member is energized only during the period in which the on-off valve 3 is in the open state, and remains de-energized during the period in which the on-off valve 3 is in the closed state, thereby guaranteeing stable positioning of the transition valve core 13 in the open state.

In one embodiment, the waterway structure further includes a reset assembly 16. The reset assembly 16 is connected respectively to the outer peripheral surface of the transition valve core 13 and to the inner wall of the on-off valve 3. The reset assembly 16 is configured to drive the transition valve core 13 to rotate and reset from the second angular position back to the first angular position.

The reset assembly 16 may employ an elastic component that possesses the function of storing and releasing elastic potential energy. One end of the reset assembly 16 is fixedly connected to the outer peripheral surface of the transition valve core 13, and the other end is fixedly connected to the inner wall of the valve cavity 303 of the on-off valve 3. During the rotation process of the transition valve core 13, the reset assembly 16 undergoes corresponding elastic deformation, thereby applying to the transition valve core 13 a force opposite to the direction of rotation. When the on-off valve 3 is in the closed state, the transition valve core 13 is at the first angular position and the reset assembly 16 is in its initial state. When the on-off valve 3 is in the open state, water flows from the second water inlet 301 into the valve cavity 303 and impacts the transition valve core 13, thereby generating a driving torque about the preset axis. When the driving torque exceeds the resisting torque applied by the reset assembly 16 to the transition valve core 13, the transition valve core 13 overcomes the elastic force of the reset assembly 16 and rotates along the self-adjusting direction. During the rotation process, the reset assembly 16 is progressively stretched, compressed or twisted, thereby increasing the stored elastic potential energy and progressively incressing the reverse torque applied to the transition valve core 13. When the transition valve core 13 rotates to the second angular position, the water flow passage 1301 is aligned with the second water inlet 301 and the second water outlet 302 and the on-off valve 3 is fully opened, at which time the reset assembly 16 is in its maximum energy-storage state. When the impact force of the water flow decreases or the external control system cuts off the upstream water supply, the driving torque exerted by the water flow on the transition valve core 13 decreases correspondingly. When the driving torque becomes smaller than the reset torque generated by the elastic potential energy stored in the reset assembly 16, the reset assembly 16 releases the stored energy, applies to the transition valve core 13 a torque opposite to the self-adjusting direction, and thereby drives the transition valve core 13 to rotate in the reverse direction until the transition valve core 13 returns to the first angular position, the water flow passage 1301 is offset from the second water inlet 301 and the second water outlet 302, the water flow is blocked, and the on-off valve 3 returns to the closed state.

In one embodiment, the reset assembly 16 is a torsion spring. The torsion spring includes a main body portion 1601, a first arm 1602 and a second arm 1603. The main body portion 1601 is sleeved on one end of the transition valve core 13, the first arm 1602 is connected to the outer peripheral surface of the transition valve core 13, and the second arm 1603 is fixedly connected to the inner wall of the on-off valve 3.

The main body portion 1601 of the torsion spring is constituted by a helical structure wound from spring wire. The inner diameter of which is adapted to the outer diameter of the end portion of the transition valve core 13 such that the main body portion 1601 can be sleeved on the outer periphery of the end portion of the transition valve core 13. The first arm 1602 extends from one end of the main body portion 1601 and its distal end is fixedly connected to the outer peripheral surface of the transition valve core 13 by means of plugging, clamping, welding or the like, such that the first arm 1602 rotates synchronously with the transition valve core 13. The second arm 1603 extends from the other end of the main body portion 1601 and its distal end is fixedly connected to the inner wall of the valve cavity 303 of the on-off valve 3 by means of plugging, clamping, welding or the like, such that the second arm 1603 remains stationary relative to the on-off valve 3. When the transition valve core 13 rotates about the preset axis along the self-adjusting direction under the impact force of the water flow. Because the second arm 1603 is fixed to the inner wall of the on-off valve 3 and remains stationary while the first arm 1602 rotates synchronously with the transition valve core 13, the main body portion 1601 is twisted and undergoes elastic deformation. The main body portion 1601 stores elastic potential energy due to the twisting while simultaneously applying to the transition valve core 13 a torsional torque opposite to the direction of rotation. When the transition valve core 13 rotates to the second angular position, the torsion spring is twisted to its maximum angle and stores the maximum elastic potential energy. When the impact force of the water flow decreases or disappears, the torsion spring releases the stored elastic potential energy, applies a reverse torsional torque to the transition valve core 13 through the first arm 1602, and thereby drives the transition valve core 13 to rotate in the direction opposite to the self-adjusting direction until it returns to the first angular position.

In one embodiment, a cross-sectional area of the water flow passage 1301 gradually increases along the preset water flow direction. The cross-section of the water flow passage 1301 is circular, elliptical or rectangular.

The preset water flow direction refers to the direction in which water flows from the second water inlet 301 into the water flow passage 1301 and then flows through the water flow passage 1301 toward the second water outlet 302. Along its extension path, the water flow passage 1301 has a cross-sectional area at the water-inlet port that is smaller than a cross-sectional area at the water-outlet port, such that the entire water flow passage 1301 forms a gradually expanding flow-channel structure. The shape of the cross-section of the water flow passage 1301 may be circular, elliptical or rectangular, and the manner in which the cross-sectional area increases may be linear gradient (for example, a conical expanding-hole form) or non-linear gradient (for example, a bell-mouth shape or a streamlined diffusion form). When water flows from the second water inlet 301 into the water flow passage 1301, the water enters the water-inlet port having the smaller cross-sectional area at a higher flow velocity. As the flow-channel cross-sectional area gradually increases along the flow direction, flow velocity gradually decreases along the flow direction. According to the continuity equation of fluid, under the condition of constant flow rate the cross-sectional area is inversely proportional to flow velocity, so that the larger the cross-sectional area, the lower the flow velocity. After the water flow gradually decelerates inside the water flow passage 1301, it exits the water-outlet port at a lower velocity and enters the second water outlet 302. At the same time, as the flow velocity decreases the water flow pressure correspondingly recovers, such that the water flow maintains a relatively stable pressure state when exiting the water flow passage 1301.

The waterway structure further includes a fixed bracket 4, the on-off valve 3 is connected to the fixed bracket 4. The fixed bracket 4 is adapted for mounting on an inner wall of a water heater housing 6. The fixed bracket 4 is configured to provide structural support for the on-off valve 3.

The on-off valve 3 is connected to the inner wall of the housing 6 of the water heater through the fixed bracket 4. Thereby providing stable structural support for the on-off valve 3, effectively mitigating the influence of impact force of the water flow and equipment operation vibration on the on-off valve 3, preventing the on-off valve 3 from displacing or loosening, ensuring the sealing integrity of the waterway connection, and avoiding potential water leakage hazards. At the same time, the arrangement facilitates assembly positioning of the on-off valve 3 and the entire waterway structure, improves overall structural stability, and extends the service life of the on-off valve 3.

In one embodiment, the waterway structure further includes a water flow adjustment knob 5 for user operation. The water flow adjustment knob 5 is mechanically or electrically linked with the flow regulating valve 2. The water flow adjustment knob 5 is configured to adjust the opening degree of the flow regulating valve 2.

The water flow adjustment knob 5 may be a knob, a lever, a touch slider, a button or the like. The water flow adjustment knob 5 is arranged on the front side of the housing 6 of the water heater or at another position convenient for the user to reach. Linkage connection between the water flow adjustment knob 5 and the flow regulating valve 2 is realized through a mechanical linkage mechanism or an electrical control signal. When a mechanical linkage mode is adopted, the water flow adjustment knob 5 and the valve stem of the flow regulating valve 2 are connected through a pull wire, a rack-and-pinion mechanism or a link mechanism. Such that when the user rotates or toggles the operating member, the mechanical transmission mechanism drives the valve core of the flow regulating valve 2 to move or rotate. Thereby changing the flow passage cross-sectional area between the first water inlet 201 and the first water outlet 202 and realizing regulation of the water flow rate.

When an electrical control linkage mode is adopted, a position detection component such as a potentiometer, an encoder or a Hall sensor is arranged inside the water flow adjustment knob 5. During user operation, an electrical signal corresponding to the operation angle or position is generated and transmitted to an external control system, and the external control system drives a motor or an electromagnetic actuator inside the flow regulating valve 2 to act according to the signal, thereby adjusting the opening degree of the flow regulating valve 2. Through the provision of the water flow adjustment knob 5, the user can intuitively control the magnitude of the inlet water flow rate according to actual usage requirements, satisfy flow rate demands under different water usage scenarios, and improve the operational convenience of the waterway structure as well as user experience.

In one embodiment, the water flow adjustment knob 5 is designed as a pressing-and-rotating operation structure. The pressing operation generates a control signal to open or close the on-off valve 3. That is, the pressing operation generates an electrical signal for controlling the on-off valve 3 to open or close and transmits the electrical signal to the control system of the water heater. The rotating operation generates an opening-degree adjustment signal for the flow regulating valve 2 and transmits the opening-degree adjustment signal to the control system of the water heater.

The water flow adjustment knob 5 may adopt a knob-type composite switch having a rotatable outer ring and a pressable inner core or an integral structure. During the rotating operation, the water flow adjustment knob 5 rotates around its axis, with the rotation angle corresponding to the degree of adjustment of the flow regulating valve 2. The external control system generates a corresponding opening-degree adjustment signal according to the rotation angle. The water flow adjustment knob 5 is configured to control the flow regulating valve 2 to increase or decrease its opening degree. During the pressing operation, the water flow adjustment knob 5 is pressed down along its axial direction, the pressing action triggers a triggering element such as a micro-switch or a Hall sensor, an opening or closing control signal for the on-off valve 3 is generated, and the signal is transmitted to the actuator of the on-off valve 3 or to a control system associated therewith, thereby controlling the on-off valve 3 to conduct or cut off the water flow. The pressing operation and the rotating operation can be performed independently without interfering with each other. By constructing the water flow adjustment knob 5 as a pressing-and-rotating operation structure, flow regulation and on-off control are integrated into the same operating element. Which simplifies the layout of the operation interface, reduces the number of operating elements, enables the user to complete both on-off control and flow regulation of the waterway through a single component, renders the operation more intuitive and convenient, and simultaneously lowers the manufacturing cost and assembly complexity of the complete machine.

In one embodiment, a filter component 17 is arranged between the first water inlet 201 and the inlet pipe 1, designed to filter impurities in the water flow into the waterway structure.

In the aforementioned structure, the filter component 17 may be a filter screen, a filter core or a filter sheet, and the material thereof may be stainless steel mesh, nylon mesh, porous ceramic or the like. The filter component 17 is arranged at a connection portion between the water outlet end of the inlet pipe 1 and the first water inlet 201 of the flow regulating valve 2, or is arranged inside the inlet pipe 1 at a position close to the first water inlet 201. A mesh aperture of the filter component 17 is set according to the water source quality condition and is generally 50 micrometers to 200 micrometers. The mesh aperture is configured to intercept solid impurities such as silt, rust and suspended matter in the water. Through the provision of the filter component 17, impurities in the water flow into the flow regulating valve 2 and the downstream on-off valve 3 and heating assembly are effectively intercepted, thereby preventing the impurities from attaching to the impeller 204 or flow sensor 205 inside the flow regulating valve 2 and causing a reduction in detection accuracy or jamming. Simultaneously preventing the impurities from entering the valve cavity 303 of the on-off valve 3 and affecting the rotational flexibility of the transition valve core 13. And also preventing the impurities from entering the interior of the heating assembly and causing scaling or blockage. Thus protecting normal operation of all components of the complete machine and prolonging the service life of the waterway structure and related components.

The present disclosure further provides a water heater, which includes a housing 6, a heat exchanger 7, a outlet pipe 8 and the waterway structure described above. The specific structure of the aforementioned waterway structure is as described in the foregoing embodiments. Since the present disclosure adopts all the technical solutions of all the foregoing embodiments, it at least possesses all the beneficial effects brought about by the technical solutions of the foregoing embodiments, which will not be repeated herein one by one.

The housing 6 internally defines an installation space 601, within which the waterway structure is placed. The end of the inlet pipe 1 away from the flow regulating valve 2 extends to the exterior of the housing 6 and is connected to an external water inlet channel. The heat exchanger 7 is positioned within the installation space 601. The heat exchanger 7 has a third water inlet 701 and a third water outlet 702. The third water inlet 701 is connected to the second water outlet 302, and the heat exchanger 7 is configured to heat the water flow through the waterway structure. One end of the outlet pipe 8 is connected to the third water outlet, and the other end of the outlet pipe 8 extends to the exterior of the housing 6 and outputs the hot water heated by the heat exchanger 7 to the outside.

The housing 6 is fabricated from a metal plate material, with an installation space 601 formed therein for accommodating the respective components. The waterway structure is arranged within the installation space 601. The end of the inlet pipe 1 distal from the flow regulating valve 2 extends outwardly through the housing 6 and connects with an external water inlet passage, so as to introduce municipal water supply or water tank water supply. The heat exchanger 7 is disposed within the installation space 601 and is provided with a third water inlet 701 and a third water outlet 702. The third water inlet 701 is connected to the second water outlet port 302 of the on-off valve 3 via piping. A heat exchange tube and heat exchange fins are arranged inside the heat exchanger 7, to transfer heat generated by the burner 10 or heat generated by an electric heating element to the water flow passing through the interior thereof, thereby raising the water temperature. One end of the outlet pipe 8 is connected to the third water outlet port of the heat exchanger 7, while the other end thereof extends to the exterior of the housing 6 so as to output, outwardly, the hot water that has been heated by the heat exchanger 7. External supply water enters the waterway structure via the inlet pipe 1, flows sequentially through the flow regulating valve 2 and the on-off valve 3, and then enters the heat exchanger 7 for heating. The heated hot water is output to the water-consuming end via the outlet pipe 8. By integrating the waterway structure into the water heater and by adopting the arrangement in which the on-off valve 3 is located downstream of the flow regulating valve 2 within the waterway structure, the upstream flow passage is maintained in a water-filled state prior to opening of the on-off valve 3. Thereby preventing high-speed jet flow from impinging upon the flow sensor 205 inside the flow regulating valve 2, ensuring stability of flow detection and precision of heating control, and consequently improving stability of the outlet water temperature of the water heater as well as user comfort. In addition, the housing 6 includes a lower shell 602 and an upper cover 603, the installation space 601 is formed inside the lower shell 602 and serving to accommodate the waterway structure, the heat exchanger 7, the outlet pipe 8 and other components. The lower shell 602 and the upper cover 603 is detachably connected by fasteners, which fasteners may be screws or rivets, thereby facilitating installation, maintenance and disassembly.

In one embodiment, the water heater further includes a water conduit 12, one end of the water conduit 12 is connected to the second water outlet port 302, the other end of the water conduit 12 extending around the heat exchanger 7 and thereafter being connected to the third water inlet 702. One end of the outlet pipe 8 is connected to the third water outlet port, while the other end of the outlet pipe 8 extends to the exterior of the housing 6 and outputs outwardly the hot water heated by the heat exchanger 7.

The water conduit 12 is arranged around the heat exchanger 7, allowing the water body flowing through it to absorb residual heat dissipated from the surface of the heat exchanger 7 before entering it. Thereby realizing pre-heating of cold water, reducing the cold-hot temperature difference upon entry into the heat exchanger 7, alleviating thermal shock and prolonging the service life of the heat exchanger 7. Secondly, the water conduit 12 fully utilizes the space surrounding the heat exchanger 7, enabling the pre-heating function to be achieved without additionally increasing the volume of the housing 6 and thereby rendering the overall machine structure more compact. At the same time, the water conduit 12 increases the path length of the water flow, performing a buffering and flow-stabilizing function so that the water flow entering the heat exchanger 7 is rendered more steady, which is conducive to uniform heating by the heat exchanger 7 and improves stability of the outlet water temperature. Furthermore, by recovering and utilizing the residual heat, thermal efficiency of the entire machine can be effectively enhanced and energy consumption can be reduced.

In one embodiment, the water heater further includes a burner 10 and a flue gas exhaust assembly 101, the burner 10 is arranged below the heat exchanger 7. The burner 10 is configured to combust combustible gas and thereby generate high-temperature flue gas for heating the heat exchanger 7. The flue gas exhaust assembly 101 includes a flue exhaust passage 1011 and a blower 1012. The blower 1012 is arranged above or laterally of the burner 10 to discharge, via the flue exhaust passage 1011, the flue gas produced by combustion of combustible gas in the burner 10.

The burner 10 is arranged below the heat exchanger 7 and is internally provided with a nozzle and a combustion chamber. The nozzle is connected to a gas pipeline to inject combustible gas. The combustible gas is mixed with air inside the combustion chamber and configured to produce high-temperature flue gas. The high-temperature flue gas flows upward, passing over the surfaces of the heat exchange tubes and heat exchange fins of the heat exchanger 7, transferring heat to the water inside and raising its temperature. The flue gas exhaust assembly 101 includes the flue exhaust passage 1011 and the blower 1012. One end of the flue exhaust passage 1011 is connected to a smoke-collecting hood located above the heat exchanger 7, while the other end thereof extends to the exterior of the housing 6 and is configured to discharge the heat-exchanged flue gas to the outdoors. The blower 1012 may be arranged above or laterally of the burner 10, its air inlet communicating with the combustion chamber and its air outlet communicating with the flue exhaust passage 1011. When the blower 1012 operates, negative pressure or positive pressure is generated to forcibly draw in the flue gas produced by the burner 10 and expel the same along the flue exhaust passage 1011, thereby ensuring timely discharge of combustion waste gas to the outdoors and preventing flue gas backflow or leakage. By providing the burner 10 and the flue gas exhaust assembly 101, the water heater is able to utilize the high-temperature flue gas generated by combustion of combustible gas to rapidly heat the water flow, possessing the advantages of high heating efficiency and rapid response speed, while the flue gas exhaust assembly 101 guarantees safe discharge of combustion waste gas and thereby enhances safety of use of the entire machine.

In one embodiment, the water heater further includes an operation panel 9 arranged on a front side of the housing 6. The operation panel 9 is provided with a temperature adjustment component 11 and a water flow adjustment knob 5. The temperature adjustment component 11 is connected to a heating power control unit of the burner 10. The temperature adjustment component 11 is configured to adjust the heating power of the burner 10 according to a temperature set by a user.

The operation panel 9 is arranged on the front side of the housing 6, to facilitate observation and operation by the user. The operation panel 9 is provided with the temperature adjustment component 11, which may be configured in the form of a knob, a push button, a touch-type slider or the like. The temperature adjustment component 11 is electrically connected to the heating power control unit of the burner 10, which controls the heating power output of the burner 10, such as by adjusting the opening degree of a gas proportional valve or the duty cycle of an electric heating element. When a user sets a target water temperature via the temperature adjustment component 11, the heating power control unit receives the set value and, in conjunction with the actual water flow rate detected by the flow regulating valve 2, calculates the required heating power and correspondingly adjusts the gas supply quantity of the burner 10 or the power of the electric heating element so that the water temperature output by the heat exchanger 7 reaches the temperature set by the user. By providing the operation panel 9 and the temperature adjustment component 11, the user can flexibly set the outlet water temperature according to actual requirements, while the heating power control unit automatically adjusts the heating power according to the set value, thereby realizing precise control of water temperature and enhancing the intelligence level of the water heater as well as user experience.

The above are merely exemplary embodiments of the present disclosure and are not intended to limit the patent scope of the present disclosure. Any equivalent structural modifications made under the technical concept of the present disclosure by utilizing the contents of the description and drawings of the present disclosure, or any direct or indirect applications thereof in other relevant technical fields, shall all fall within the scope of patent protection of the present disclosure.

What is claimed is:

1. A waterway structure, comprising:
an inlet pipe; and
a flow regulating valve having a first water inlet and a first water outlet, the first water inlet being connected to the inlet pipe; and
an on-off valve having a second water inlet and a second water outlet arranged opposite to each other, the second water inlet and the second water outlet being fluidly aligned to establish a continuous flow path along a preset water flow direction, and the second water inlet being connected to the first water outlet, and the second water outlet is configured to be connected to a heating assembly; and
a transition valve core rotatably disposed in a valve cavity of the on-off valve about a predetermined axis, the predetermined axis being perpendicular to the preset water flow direction; the transition valve core is provided with a water flow passage extending therethrough along a flow direction, the flow direction being perpendicular to the predetermined axis;
wherein, when the on-off valve is in a closed state, the valve cavity is isolated from an upstream flow passage of the on-off valve, and the transition valve core is positioned at a first angular position relative to the on-off valve such that the flow direction is perpendicular to the preset water flow direction; and
when the on-off valve is in an open state, the valve cavity is communicated with the upstream flow passage of the on-off valve, and the transition valve core rotates relative to the on-off valve in a self-adjusting direction under an impact force of the water flow entering the valve cavity to a second angular position, thereby aligning the water flow passage with both the second water inlet and the second water outlet.

2. The waterway structure of claim 1, wherein the flow regulating valve comprises a valve body, an impeller, and a flow sensor;
wherein the valve body is provided with the first water inlet and the first water outlet arranged along a preset water flow direction; and
the impeller and the flow sensor are disposed within the valve body; the impeller is rotatably connected to an inner wall of the valve body along a direction perpendicular to both the first water inlet and the first water outlet;
the impeller is configured to rotate under the driving force of water flow through the first water inlet and the first water outlet; and the flow sensor is configured to generate a water flow detection signal based on rotation of the impeller.

3. The waterway structure of claim 1, wherein the inlet pipe, the flow regulating valve, and the on-off valve are arranged coaxially along the preset water flow direction; and the on-off valve is a solenoid valve or an electrically actuated valve.

4. The waterway structure of claim 1, wherein the transition valve core is configured as a cylinder extending along the predetermined axis;
wherein an outer cylindrical surface of the transition valve core is provided with a spiral groove extending circumferentially around the transition valve core; and the spiral groove is configured to allow water flow to pass therethrough.

5. The waterway structure of claim 1, wherein an outer cylindrical surface of the transition valve core is provided with a plurality of baffles arranged at intervals along the circumference of the transition valve core;
wherein the plurality of baffles is inclined relative to a radial direction of the transition valve core, and configured to drive the transition valve core to rotate about the predetermined axis under the impact force of the water flow.

6. The waterway structure of claim 5, wherein each of the plurality of baffles has a bucket-shaped structure.

7. The waterway structure of claim 6, wherein the bucket-shaped structure has a concave surface, and concave surfaces of all the bucket-shaped structures of the plurality of baffles face a same direction.

8. The waterway structure of claim 1, further comprising a limiting structure, wherein the limiting structure comprises a limiting boss and a limiting block;
wherein the limiting boss is disposed on an inner wall of the valve cavity of the on-off valve and is located at one side of the transition valve core;
the limiting block is disposed at an end of the transition valve core adjacent to the limiting boss; and
when the transition valve core rotates to the second angular position, the limiting block abuts against the limiting boss.

9. The waterway structure of claim 8, wherein one of the limiting boss and the limiting block is an electromagnetic member and the other is a permanent magnet member; and
wherein when the transition valve core rotates to the second angular position, the electromagnetic member is energized and magnetically attracts the permanent magnet member, thereby positioning the transition valve core at the second angular position.

10. The waterway structure of claim 9, wherein the electromagnetic member is energized when the on-off valve is in the open state and de-energized when the on-off valve is in the closed state.

11. The waterway structure of claim 1, further comprising a reset assembly connected to an outer peripheral surface of the transition valve core and to an inner wall of the on-off valve; wherein the reset assembly is configured to drive the transition valve core to rotate from the second angular position back to the first angular position.

12. The waterway structure of claim 11, wherein the reset assembly is a torsion spring, wherein the torsion spring comprises a main body portion, a first arm, and a second arm;
wherein the main body portion is sleeved on one end of the transition valve core; the first arm is connected to the outer peripheral surface of the transition valve core; and the second arm is fixedly connected to the inner wall of the on-off valve.

13. The waterway structure of claim 1, wherein a cross-sectional area of the water flow passage increases along the preset water flow direction.

14. The waterway structure of claim 13, wherein a cross-section of the water flow passage is circular, elliptical, or rectangular.

15. The waterway structure of claim 1, further comprising a water flow adjustment knob for user operation;
wherein the water flow adjustment knob is mechanically or electrically linked with the flow regulating valve and is configured to adjust the opening degree of the flow regulating valve.

16. The waterway structure of claim 15, wherein the water flow adjustment knob has a push-and-rotate operation structure; wherein a push operation generates an on/off control signal for the on-off valve, and a rotate operation generates an opening-degree adjustment signal for the flow regulating valve.

17. The waterway structure of claim 1, wherein a filter component is disposed between the first water inlet and the inlet pipe; the filter component is configured to filter impurities from water entering the waterway structure.

18. A water heater, comprising:
the waterway structure of claim 1;
a housing defining an installation space configured to accommodate the waterway structure, and one end of the inlet pipe remote from the flow regulating valve is extended outside of the housing and connected with an external water supply channel;
a heat exchanger disposed within the installation space; wherein the heat exchanger having a third water inlet and a third water outlet, the third water inlet is connected to the second water outlet; wherein the heat exchanger is configured to heat water flow through the waterway structure;
an outlet pipe, one end of the outlet pipe is connected to the third water outlet and the other end is extended outside of the housing to output hot water heated by the heat exchanger.

19. The water heater of claim 18, further comprising a burner and a flue gas exhaust assembly;
wherein the burner is disposed below the heat exchanger and is configured to combust combustible gas to generate high-temperature flue gas for heating the heat exchanger;
the flue gas exhaust assembly comprises a flue exhaust passage and a blower; and
the blower is disposed above or beside the burner and is configured to discharge flue gas generated by combustion of the combustible gas through the flue exhaust passage.

20. The water heater of claim 19, further comprising an operation panel disposed on a front side of the housing;
wherein the operation panel is provided with a temperature adjustment component and a water flow adjustment knob; wherein the temperature adjustment component is connected to a heating power control unit of the burner and is configured to adjust the heating power of the burner according to a temperature set by a user.
